(19) United States
(12) Patent Application Publication
(10) Pub. No.: US 2011/0003040 A1
(43) Pub. Date: Jan. 6, 2011

(54) CULINARY CAPSULE

(75) Inventors: Bjorn Graf, Konstanz (DE); Markus Hartmann, Radolfzell (DE); Doris Chng, Kuala Lumpur (MY); Philippe Duboc, Bern (CH); Fritz Wilhelm Nueckel, Singen (DE)

Correspondence Address: K&L Gates LLP, P.O. Box 1135, CHICAGO, IL, 60690, US

(73) Assignee: NESTEC S.A., Vevey (CH)

(21) Appl. No.: 12/867,827

(22) PCT Filed: Jan. 26, 2009
(86) PCT No.: PCT/EP2009/050840

§ 371 Date: Aug. 16, 2010

(30) Foreign Application Priority Data
Feb. 19, 2008 (EP) 08151623.9

(51) Int. Cl. B65D 85/816; A23L 1/40; A23L 2/39; A23L 1/216; A23P 1/12; A47J 27/00

(52) U.S. Cl. 426/98; 426/665; 426/431; 426/443; 426/560; 99/324

(57) ABSTRACT

Described is a capsule comprising a plurality of compacted food articles comprising a dehydrated food powder mixed in a fat-based binding system. A method for the production of the capsule is further described.

### FIELD OF THE INVENTION

The present invention relates to capsules comprising food ingredients which upon reconstitution with hot liquid using a dispensing system can provide food products such as hot soups, sauces, mashed potatoes, etc. The present invention also relates to the use of said capsules, to a system for the production of an instant food product and to food pellets which may be used in the present capsules.

### BACKGROUND OF THE INVENTION

Capsules for dispensing hot and/or cold beverages using a dispensing system are well known in the art. These capsules are known for instance from EP 1 472 156. Dispensing machines and the capsules usable therein are commonly found on the market. The beverages which may be produced by such machines and capsules are generally coffee products, hot chocolates or teas.

The ingredients present in the commercially available cartridges are usually in the form of a powder which either dissolves with the injected liquid (usually hot water), for example, in the case of the preparation of hot chocolate, milk, etc. Alternatively, the powder inside the capsule is extracted with the injected liquid, in the case of coffee. The result is a beverage which has low viscosity.

Savoury beverages which can be prepared using a capsule and a dispensing machine are however less common. A clear Consommé from Knorr which can be dispensed on a Lavazza Blue machine has been made available on the market of culinary products. This is however not a thick, creamy food product.

Instant creamy soup formulations are described in GB 1464429. The agglomerated ingredients include pre-gelatinised binding agents coated with fat and other ingredients. However, the patent does not address the use of a cartridge-based system to prepare the soup, nor the modifications needed to the powder if said soup is to be prepared from a cartridge-based beverage system.

### OBJECT OF THE PRESENT INVENTION

The present object is thus to provide a way in which beverages or food products with a thicker consistency than traditional beverages may be prepared using a capsule and beverage dispensing machine.

### SUMMARY OF THE PRESENT INVENTION

The present object is solved by means of the independent claims. The dependent claims further develop the central idea of the invention.

Thus, in a first aspect, the present invention provides a capsule comprising a plurality of compacted food pellets comprising a dehydrated food powder mixed in a fat-based binding system.

In a further aspect of the invention, the present invention relates to the use of a capsule according to any of claims 1 to 28 in the preparation of an instant food product.

A method for the production of a capsule according to any of claims 1 to 28, comprising the step of
a. preparing food pellets by mixing dehydrated ingredients with a fat-based binding system and pressing or extruding the mixture to obtain said pellets and
b. Filling a capsule with a plurality of said pellets,
   also forms part of the present invention.

Furthermore, a system for the production of an instant food product, comprising a machine and a capsule according to any of claims 1 to 28, wherein the machine comprises means to extract said capsule placed in said machine by injecting hot liquid in said capsule, and wherein the capsule comprises means for being extracted by said hot liquid and means for allowing an instant food product to flow out of said capsule, is also provided by the present invention.

Finally, the present invention also relates to a compacted food pellet comprising a dehydrated food powder mixed in a fat-based binding system, wherein the fat-based binding system comprises a mixture of fat, flour, starch and gum. Said article can be in the shape of a pellet, lentil, briquette, pebble, dragee, pillow, egg or ball.

### FIGURES

The present invention is further described hereinafter by reference to the accompanying figures, wherein:

FIG. 1 is a graph comparing dissolution of powders (comprised in traditional capsules) and pellets (contained in the capsules according to the present invention),

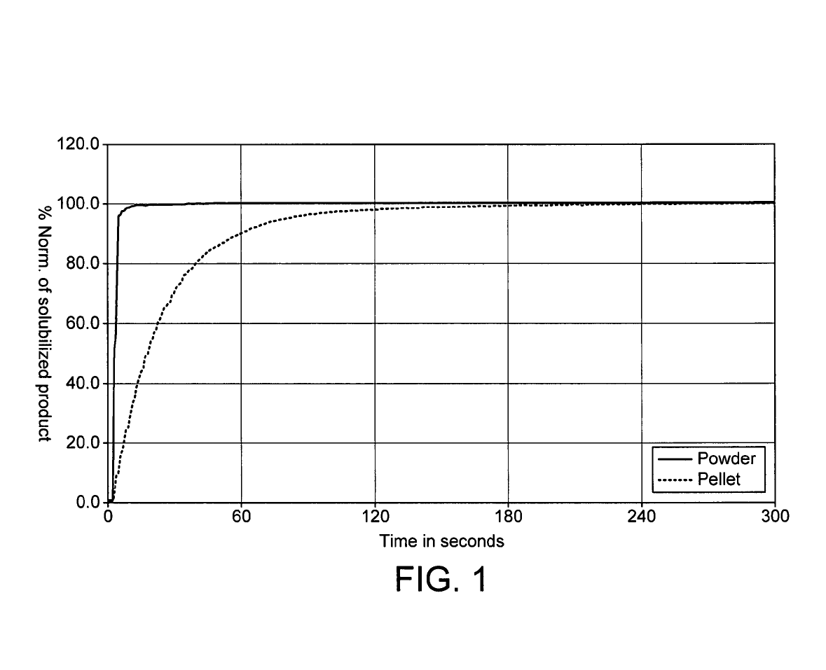

FIG. 2 is a schematic diagram of the mass flow over time of a powder compared to a fat-based pellet as used in the capsules of the invention, and

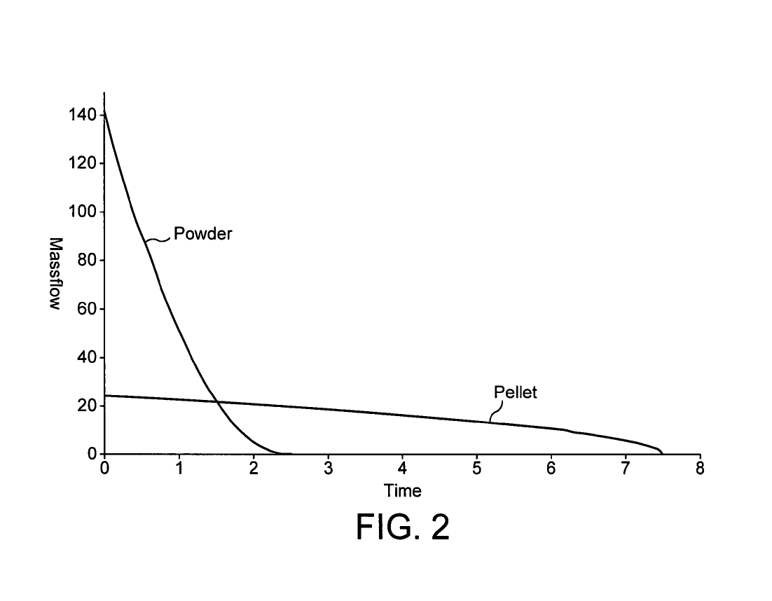

FIG. 3 is a schematic sectioned view of an example of a capsule.

### DETAILED DESCRIPTION OF THE INVENTION

The present invention relates to capsules comprising a plurality of compacted food pellets. The pellets comprise a dehydrated food powder mixed in a fat-based binding system.

The capsules may be of any type which can be used in a beverage dispensing machine. Typical capsules which may be used in the present invention are those described for instance in EP 1 472 156 B1. The capsules therein described are designed to be extracted by injection of a fluid under pressure in an extraction device. Each capsule comprises its own opening means activated by the rise of pressure of the fluid introduced into the capsule at the time of its extraction. Further, the capsule has its own outflow passage with its own ducting means making it possible to avoid or at the very least considerably reduce contact with the elements of the system of the extraction device.

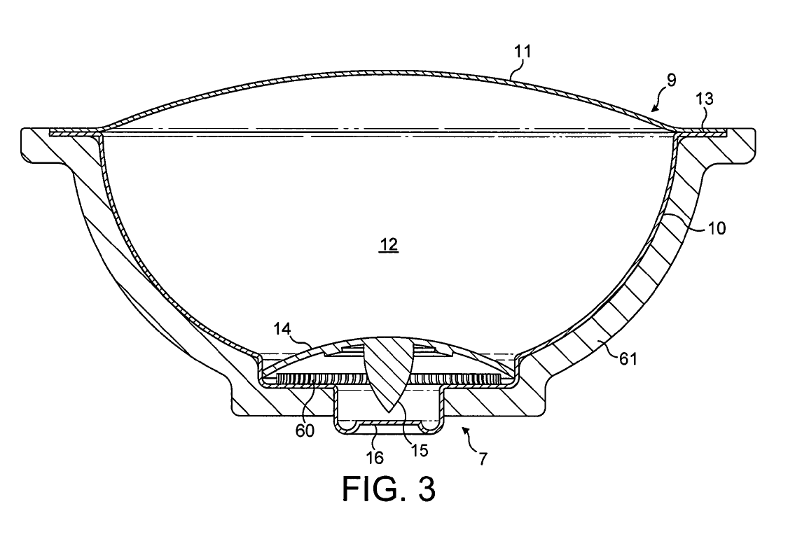

FIG. 3 shows an example of a capsule which can be used to incorporate the food ingredients. This capsule comprises a cup (10) and a membrane (11) welded at a peripheral welding edge (13) forming the periphery of the said cup. The capsule contains food ingredients (12). The system for opening the capsule consists of a disc (14) arranged in the bottom of the cup (10) and comprising a puncturing point (15) and a filter (60). The puncturing point is therefore enclosed in the chamber formed by the cup (10) and the membrane (11). The disc is thus arranged at the bottom of the cup and thus forms a wider area over which the internal pressure may be spread during extraction. At the time of extraction, the capsule is introduced into the extraction device, water is introduced via a needle which punctures the membrane (11), and under the effect of the rise in pressure in the capsule, the disc (14) experiences a downward thrust towards the retaining part (16) so that the point (15) punctures the retaining part (16) of the cup, thus allowing the food product to flow out. The capsule is held firmly in place by virtue of the support (61) and the filter (60) prevents remainders from passing into the mug (not depicted) situated under the said capsule.

The capsule of the present invention is preferably a sealed capsule. It is typically designed to be extracted by injection of fluid under pressure in an extraction device. Preferably, the capsule comprises a closed chamber containing the pellets and a means allowing said capsule to be opened at the time of its use and for allowing a beverage or food product to flow out.

The food pellets which are present in the capsule are compacted. Thus, they have a higher density than powders which are normally used in capsules. Typically, the density of the food pellet is between 1.0 to 1.5 g/cm³.

The food article comprises a dehydrated food powder mixed in a fat-based binding system. By “food” is meant any consumable ingredient. Thus, the dehydrated food powder may be any dried ingredient such as those used in soup powders, sauce powders, mashed potato powders, chocolate powder, creamer, milk powder and soluble beverage powders.

The fat-based binding system to which the dehydrated food powder is mixed preferably comprises a mixture of fat, flour, starch and gum. Typically, the binding system comprises 30-40 wt % fat, 40-50 wt % flour, 10-15 wt % starch and 5-10 wt % gum.

In a preferred embodiment, the binding system is a mixture of palm fat, wheat flour, potato starch and guar gum. In the case of chocolate based beverage, it is conceivable that the binding system would comprise at least some cocoa butter as the fat component.

Binding systems are normally used to obtain thick creamy soups. They usually comprise modified or non-modified starches, flours or gums.

In the case of capsules however, where space is limited, traditional binding systems do not work efficiently. It was found that the present fat-based binding system overcomes the space limitation by providing enhanced binding properties. The fat-based binding system was particularly advantageous when incorporated in a compacted article comprising the dried ingredients. Indeed, the binding system allows the capsule contents to be homogeneously released from the capsule, while thickening the resulting product when reconstituted with water, without causing blockage during dispensing. Furthermore, using the fat-based binding system as in the present invention allows the dispensing of larger amounts of product from one capsule than when traditional binding systems are used.

Preferably, the dehydrated food ingredients are embedded in the fat-based binding system. Indeed it was found that the incorporation of the powder into the fat-based binding system and a compaction of the mixture to a food article were particularly advantageous as it provided a homogeneous release of the soup, when using a beverage dispensing machine.

To produce the food articles, the dehydrated food ingredients are mixed with the fat-based binding system and subsequently agglomerated.

Preferably, the dehydrated ingredients are mixed with the fat-based binding system in a dehydrated ingredients: binding system ratio of 50:50 to 90:10.

The compaction can then be achieved by pressing or extruding the mixture. Pressing is typically carried out with any of flat die pelleting presses, gear-shaped press rollers, punch and die presses, roller presses. Extrusion can typically be carried out with any of screen and basket extruders, radial, axial and dome extruders, flat and ring die extruders, axial screw extruders, hollow perforated cylinders.

The preferred technology used is a flat die pelleting press as it allows controlling the density of the food articles within a wider range compared to the other technologies.

Typically, the food articles are in the form of a pellet, lentil, briquette, pebble, dragee, pillow, egg or ball. Preferably, the food articles have a height dimension of between 1 to 10 mm, more preferably 5 mm.

It has been found that the surface to volume ratio of the food articles is preferably between 0.9 to 3.5 mm⁻¹. More preferably, it is between 0.95-3.33 mm⁻¹, even more preferably 1.3-2.1 mm⁻¹.

Such surface ratio contributes in obtaining a homogeneous concentration of the soup in a capsule-based system.

Indeed, as soon as a hot liquid, typically water with a temperature of about 85° C. is injected into the capsule, the fat starts melting and thus releasing the food product mass, e.g. soup.

If the surface to volume ratio is too high, e.g. higher than 3.5 mm⁻¹, the release of the food product mass will be too quick, leading to a non-homogeneous distribution of the product during dispensing. In this case, for instance, the food articles present in the capsule would be dissolved in the first 50 mL of liquid flowing out of the capsule. Thus, the surface to volume ratio is preferably below 3.5=⁻¹.

If, however, the surface to volume ratio is too low, e.g. lower than 0.9 mm⁻¹, the melting rate of the fat in the food articles will be too slow and as a consequence product will remain in the capsule after dispensing.

The food articles of the invention preferably comprise fat in an amount of 5-65 wt %, starch in an amount of 1-10 wt %, gum in an amount of 1-5 wt %, flour in an amount of 10-30 wt %. Furthermore, the food articles may comprise any of salt, sugar, flavours, emulsifiers, maltodextrin, whey protein powder, creamer, wheat gluten hydrolysate, or any combinations thereof.

The capsule of the invention typically contains 5 to 15 g of food articles. This amount provides a good consistency to a product upon extraction with 100 to 250 mL of hot liquid, e.g. hot water.

Thus, the use of the present capsules in the preparation of an instant food product forms part of the present invention.

Typically, the use comprises placing the capsule in a beverage system and allowing the contents of said capsule to be extracted. Preferably, the contents of the capsule are extracted with hot water, more preferably about 100-200 mL of hot water.

The instant food product obtained by the use of the present capsules may be a soup, a sauce, mashed potatoes, a hot beverage, e.g. hot chocolate.

The instant food product is characterised by a creamy consistency which varies in thickness depending on the intended product. In any case, the product obtained is creamier and thicker than traditional products obtained using traditional capsules in a dispensing system. Furthermore, no problems of blockage due to the viscosity of the end product are observed. Thus, it is possible with the present invention to provide a broader range of products, which extends beyond the usual beverages such as coffee, tea, hot chocolate to instant food products such as mashed potatoes, sauces for instance.

The present invention also offers the advantage that no further stirring is required since the food product is dispensed in a very homogeneous manner. Furthermore, the single-portioned beverage or food product is convenient for the consumer.

The present method for the production of a capsule according to any of claims 1 to 28, comprises the first step of preparing food articles by mixing dehydrated ingredients with a fat-based binding system and pressing or extruding the mixture to obtain said food articles. The preparation of the food articles may be carried out as described above. In a second step, the capsule is filled with a plurality of said food articles.

A system for the production of an instant food product also falls within the present invention. The system comprises a machine and a capsule as described above. The machine comprises means to extract a capsule placed in said machine by injecting hot liquid in said capsule. The capsule comprises means for being extracted by said hot liquid and means for allowing an instant food product to flow out of said capsule.

In a further aspect of the invention, a compacted food article comprising a dehydrated food powder mixed in a fat-based binding system, wherein the fat-based binding system comprises a mixture of fat, flour, starch and gum is provided. Preferably, the food article has a surface to volume ratio of 0.9 mm⁻¹ to 3.5 mm⁻¹.

The present invention is further illustrated hereinafter with the following non-limiting examples.

### EXAMPLES

### Example 1

Recipe of a food pellet contained in a capsule for the preparation of an instant soup.

| Ingredient | Amount (wt %) |
|---|---|
| Fat-based binding system | 40-50% |
| Creamer | 15-20% |
| Maltodextrin | 5-15% |
| Salt | 0.1-10% |
| Whey protein powder | 0.1-5% |
| Sugar | 0.1-2% |
| Wheat gluten hydrolysate | 0.5-5% |
| flavours | 10-20% |

Fat-based binding system composition

| Ingredients | Amount (wt %) |
|---|---|
| Wheat flour | 40-50% |
| Potato starch | 10-15% |
| Palm fat | 30-40% |
| Guar gum | 5-10% |

### Example 2

In order to measure the quantity of solubilised product after 10 s, pellets of the invention and non-compacted powder were poured into a recipient comprising hot water (80° C.)

The measuring equipment was a conductivity meter CDM 22

1. Capsule comprising a plurality of compacted food articles that comprise a dehydrated food powder mixed in a fat-based binding system.

2. Capsule according to claim 1, wherein the food articles have a surface to volume ratio of 0.9 to 3.5 mm⁻¹.

3. Capsule according to claim 1, wherein the surface to volume ratio of the food articles is between 1.3 to 2.1 mm⁻¹.

4. Capsule according to claim 1, wherein the binding system comprises a mixture of fat, flour, starch and gum.

5. Capsule according to claim 1, wherein the binding system comprises 30 to 40 wt % fat, 40 to 50 wt % flour, 10 to 15 wt % starch and 5 to 10 wt % gum.

6. Capsule according to claim 1, wherein the binding system comprises a mixture of palm fat, wheat flour, potato starch and guar gum.

7. Capsule according to claim 1, wherein the food articles are in a form selected from the group consisting of a pellet, lentil, briquette, pebble, dragee, pillow, egg and ball.

8. Capsule according to claim 6, wherein the food articles have a height dimension of between 1 and 10 mm.

9. Capsule according to claim 1, wherein the dehydrated food powder is selected from the group consisting of soup powders, sauce powders, mashed potato powders, chocolate powder, soluble beverage powders and milk powder.

10. Capsule according to claim 1, wherein the food pellets comprise fat in an amount of 5 to 65 wt %, starch in an amount of 1 to 10 wt %, gum in an amount of 1 to 5 wt %, and flour in an amount of 10 to 30 wt %.

11. Capsule according to claim 1, wherein the food powder includes ingredients selected from the group consisting of salt, sugar, flavours, emulsifiers, maltodextrin, whey protein powder, creamer, wheat gluten hydrolysate, and combinations thereof.

12. Capsule according to claim 1, wherein each pellet has a density of 1.0 to 1.5 g/cm³.

13. Capsule according to claim 1, which comprises 5 to 15 g of food pellets.

14. Capsule according to claim 1, which is a sealed capsule.

15. Capsule according to claim 1, that is designed to be extracted by injection of a fluid under pressure in an extraction device.

16. Capsule according to claim 1, comprising a closed chamber containing the food articles and a means allowing the capsule to be opened at the time of its use and for allowing a beverage to flow out.

17. A method for the preparation of an instant food product comprising using a plurality of compacted food articles that comprise a dehydrated food powder mixed in a fat-based binding system.

18. Method according to claim 17, comprising placing the capsule in a beverage system and allowing the contents of said capsule to be extracted.

19. Method according to claim 18, wherein the contents of the capsule are extracted with hot water.

20. Method according to claim 19, wherein the contents of the capsule are extracted with 100 to 200 mL of hot water.

21. Method according to claim 17, wherein the food product is selected from the group consisting of a soup, a sauce, mashed potatoes, beverage and savoury drink.

22. Method for the production of a capsule comprising a plurality of compacted food articles comprising the step of
preparing food pellets by mixing dehydrated ingredients with a fat-based binding system and pressing or extruding the mixture to obtain the food articles; and
filling a capsule with a plurality of the food articles.

23. Method according to claim 22, wherein the dehydrated ingredients are mixed with the fat-based binding system in a dehydrated ingredients:binding system ratio of 50:50 to 90:10.

24. Method according to claim 22, wherein the pressing is carried out using a press selected from the group consisting of flat die pelleting presses, gear-shaped press rollers, punch and die presses, and roller presses.

25. Method according to claim 22, wherein the extruding is carried out with an extruder selected from the group consisting of screen and basket extruders, radial, axial and dome extruders, flat and ring die extruders, axial screw extruders, and hollow perforated cylinders.

26. System for the production of an instant food product, comprising a machine and a capsule comprising a plurality of compacted food articles that comprise a dehydrated food powder mixed in a fat-based binding system, wherein the machine comprises means to extract a capsule placed in the machine by injecting hot liquid in the capsule, and wherein the capsule comprises means for being extracted by the hot liquid and means for allowing an instant food product to flow out of the capsule.

27. Compacted food pellet comprising a dehydrated food powder mixed in a fat-based binding system, the fat-based binding system comprises a mixture of fat, flour, starch and gum.

28. Food pellet according to claim 27, wherein the pellet has a surface to volume ratio of 0.9 mm⁻¹ to 3.5 mm⁻¹.
